(19) United States
(12) Patent Application Publication
(10) Pub. No.: US 2022/0245540 A1
(43) Pub. Date: Aug. 4, 2022

(54) METHOD FOR EVALUATING THE LEVEL OF TRUST AND EXPECTATIONS OF USERS TOWARD PUBLIC AND/OR PRIVATE ORGANISATIONS

(71) Applicant: KPI6.COM S.R.L., Rubiera (RE) (IT)

(72) Inventors: Alberto NASCIUTI, REGGIO EMILIA (RE) (IT); Veronica IOVINELLA, ROMA (RM (IT); Marco MAZZA, REGGIO EMILIA (RE) (IT); Gaetano BONOFIGLIO, ROMA (RM) (IT); Andrea SALVONI, ROMA (RM) (IT); Gaetano MASI, FANO (PU) (IT)

(21) Appl. No.: 17/585,674

(22) Filed: Jan. 27, 2022

(30) Foreign Application Priority Data
Jan. 29, 2021 (IT) 102020000027498

(51) Int. Cl. G06Q 10/06

(52) U.S. Cl. CPC G06Q 10/0637

(57) ABSTRACT

A method for evaluating the level of trust and expectations of users toward public or private organisations, including collecting a plurality of data from various data sources; generating, based on such data, a first user trust index, a second user perception index for a given organisation and a third index measuring how much a product or service is likely to be spread among users; splitting users, by an analysis tool into user groups based on predefined features; generating a quadrant with two dimensions defining four separate sections with different profiles of organisations, each organisation represented by a point in at least one section, the values of the two dimensions and the value of a third dimension coinciding with the dimension of each point, determined by the three indices; applying the analysis tool to evaluate the differences of users in organisations in a particular section of the quadrant, to allow organisations to direct—on specific user brackets—a set of predefined actions for improving the positioning thereof in the quadrant, by modifying the index values.

This application claims priority to Italian Patent Application No. 102020000027498 filed on Jan. 29, 2021.

### TECHNICAL FIELD

The present invention generally relates to a method for evaluating the level of trust and expectations of users toward public and/or private organisations and, in particular, to a method which generally aims at improving, simplifying and speeding up the analysis of consumer expectations so that private businesses and/or statutory corporations can reorganise and make their production processes more efficient.

### BACKGROUND

Currently, collecting information, analysing it, understanding it and therefore evaluating the level of trust and expectations of users (both as consumers and as citizens) with respect to any entity, such as for example statutory corporations, local governments, private businesses, etc., requires implementing conventional and therefore demanding, survey methods, consisting of listening to the citizen. These methods may comprise, for example, initial data collection steps, such as questionnaires, telephone interviews, and focus groups. Subsequently, the data collected must be processed separately and the information useful for analysing the expectations of the users must be extracted from such processing.

Information collection methods based on specific algorithms, such as for example those illustrated in the document US 2012/296845 A1, have therefore been implemented. As a matter fact, the method according to US 2012/296845 A1 uses a Sentiment Analysis based algorithm, which is an essentially semantic analysis whose purpose is to identify and extract specific information from a written text. Although it is clearly more effective than conventional survey methods, unless assisted by further algorithms designed, for example, to identify human emotions, a Sentiment Analysis based algorithm is not perfectly capable of accurately measuring the level of trust and user expectations toward a particular organisation.

### SUMMARY

Therefore, an object of the present invention is to provide a method for evaluating the level of trust and expectations of users toward public and/or private organisations that is capable of overcoming the aforementioned drawbacks of the prior art in an extremely simple, quick and particularly functional manner.

This object according to the present invention is achieved by providing a method for evaluating the level of trust and expectations of users toward public and/or private organisations as disclosed in claim 1.

Further characteristics of the invention are outlined by the dependent claims, which are an integral part of the present description.

### BRIEF DESCRIPTION OF THE DRAWINGS

The characteristics and advantages of a method for evaluating the level of trust and expectations of users toward public and/or private organisations according to the present invention will be more apparent from following description—provided by way of non-limiting example—with reference to the attached schematic drawings wherein:

FIG. 1 is a block diagram showing the steps of the method for evaluating the level of trust and expectations of users toward public and/or private organisations according to the present invention;

FIG. 2 is a graphical representation of an analysis tool of the method for evaluating the level of trust and expectations of users toward public and/or private organisations according to the present invention, which allows to compare user groups based on various metrics; and

FIG. 3 is a quadrant showing the profiles of public and/or private organisations relating to the evaluation indices obtained through the method for evaluating the level of trust and expectations of users toward public and/or private organisations according to the present invention.

### DETAILED DESCRIPTION

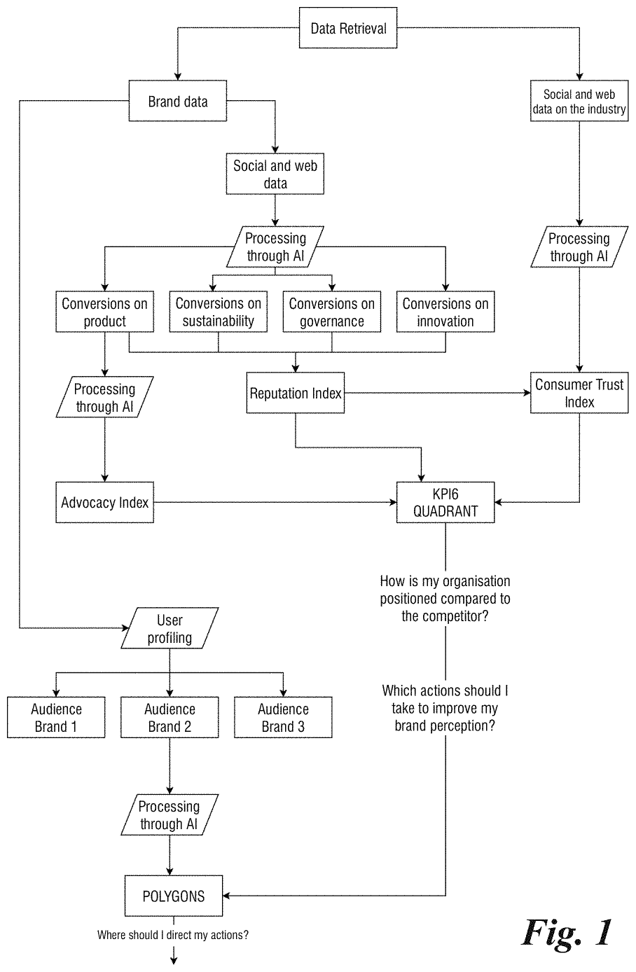

With reference in particular to FIG. 1, the steps of the method for evaluating the level of trust and expectations of users toward public and/or private organisations according to the present invention are shown. The method comprises a step for collecting a user-generated textual dataset (“user generated contents” or UGC) on web platforms, such as for example forums, blogs and websites, and/or social networks, such as for example Twitter, Facebook, Instagram etc. The purpose is to build a user/consumer trust index (Consumer Trust Index or C-TI).

UGCs are collected through Boolean keyword queries launched directly by a predefined algorithm, complying with rules and operators of the various source platforms. Given the purpose of evaluating the level of trust of a given user toward a determined industry, queries are built starting from a monitoring of hashtags, mentions, user profiles and keywords most used regarding the industry subject of examination, and this is within a predefined time horizon, for example, this is the last 30 days prior to the start of the analysis. Lastly, a language operator, which allows to select determined UGCs in one or more languages of interest, can be applied to the queries thus generated.

Therefore, the method comprises a step for processing and analysing the UGCs. More particularly, this step for processing and analysing the UGCs provides for conducting two separate analyses carried out with two respective artificial intelligence algorithms. The collected UGCs are then enriched with the aforementioned algorithms and they are subsequently aggregated using a simple mean. The result thus obtained is subjected to smoothing using the mobile mean technique (base equal to seven days). Lastly, the Consumer Trust Index (C-TI) is shown as a fixed-base index, where the base coincides with the first day of the series under examination.

A first Sentiment Analysis based algorithm is trained starting from a set of a predefined amount (for example about 1.3 million) of text portions (“posts”) on social networks in Italian and English. By way of example, this set of posts could be at least partly obtained from a well-known dataset referred to as Sentiment140, which contains predominantly data in English, and partly from posts actually downloaded from certain social networks, for example those that use Italian.

The model of the first algorithm mainly consists of two blocks. A first block is represented a language model which allows to extract features with highly predictive content from a text, that is the activations of one of the last layers of the model. By way of example, this language model could consist of Google BERT, which is a huge Google-trained language model. A second block consists of a Wide CNN (Wide Convolutional Neural Network) which, thanks to its particular architecture, can exploit the constructs of each text portion by analysing unigrams, bigrams and trigrams.

The “training” process is carried out in two steps. A first step provides for saving the results of the language model computations, which can be seen as the new embeddings from which training is carried out with respect to the second block of the algorithm, that is the Wide CNN. Compared to conventional embeddings, an increase in performance using the aforementioned Google BERT was observed. The result of the first Sentiment Analysis algorithm is a distribution of each text portion between two sets (positive and negative), where a threshold is applied to establish the neutrality margins of each text portion.

The second algorithm, Emotion Analysis based algorithm, still provides for the analysis of a predefined amount (for example about 1 million) of text portions (“posts”) on social networks. Basically, Emotion Analysis uses the same architecture as the first Sentiment Analysis algorithm. The emotions which can be identified and analysed in each text portion can be selected, for example, from the group consisting of:
joy,
admiration,
sadness,
fear,
anger,
disapproval,
surprise,
malice,
boredom.

Once analysed by the first and second algorithm, the UGCs are stored in appropriate datasets. These Sentiment Analysis and Emotion Analysis datasets can be multilingual datasets obtained as a combination of previously labelled open source datasets and original datasets collected and labelled within the scope of the method according to the invention. In particular, the Sentiment Analysis dataset may consist, as pertains to the English part, of the Sentiment140 open source dataset, integrated with an original dataset for the other languages, while the Emotion Analysis dataset may be entirely original.

Given the application domain, that is short textual data extracted from social network contexts, these textual data are collected in several samples extracted over different periods of time, so as to facilitate the generality of the language. The raw dataset thus generated is subsequently cleaned, deleting nonsensical text portions and/or removing or masking the noise elements for the possible classifier (noise-cancelling step).

The technique used to construct dataset labels is based on the technique described in Sentiment140, called distant supervision. As regards Sentiment Analysis it is a matter of extracting the polarity of the text portion from the emojis contained therein. As regards Emotion Analysis a slightly different approach, for example inspired and freely adapted from the DeepMoji model, can instead be used. Instead of directly predicting the emotion expressed by the data textual portion, the emoji contained in the data item is predicted and the prediction is subsequently converted into emotion based on an original emoji-emotion classification, based on the emotional spectrum studies by P. Ekman and R. Plutchik.

Consumer Trust Index (C-TI) is therefore an index that allows businesses and/or organisations to understand their customers and/or users more in depth and in real time. Consumer Trust Index (C-TI) is a real-time indicator of how the trust—intended as positiveness, “sentiment”, likelihood to buy—of the people, whether customers, users, or consumers—evolves day by day. Although Consumer Trust Index (C-TI) works like conventional trust indices, it offers prompt insights, collected using a reliable and unsolicited method. Consumer Trust Index (C-TI) takes into account any type of business, organisation, and/or brand: this information can guide a brand's strategies toward its short- and medium-term goals, minimise losses to the utmost, retain customers and move closer to them and their needs.

The entire Consumer Trust Index (C-TI) dataset is weighted with proprietary artificial intelligence algorithms. For example, an emotional spectrum extraction on social content, which returns various human emotions, can be carried out. Therefore, these data are weighted and aggregated with the other insights that form the Consumer Trust Index (C-TI). Therefore, Consumer Trust Index (C-TI) allows to measure how pessimistic/optimistic consumers/citizens are about a given system, whether global or circumscribed.

Consumer Trust Index (C-TI) is based on the assumption that if consumers/citizens are optimistic (high index level), they will be more likely to spend/invest, starting positive economic cycles. By contrast, low index levels indicate the presence of pessimism, with effects contrary to those described above.

Through Consumer Trust Index (C-TI), businesses can prepare for contraction of demand, by taking specific measures in advance (for example different management of the warehouse and/or of the sales force), or intervene to optimise and predict a peak of consumption, thanks to the index alert, and therefore provide the incoming consumer with appropriate services at the time of economic turnaround.

The method for evaluating the level of trust and expectations of users toward public and/or private organisations according to the present invention also provides for creating an index which measures user perception with respect to a given public and/or private organization (Reputation Index or RI). The Reputation Index (RI) has the following characteristics:
it varies over time: it allows to measure the change in perception from day to day by crossing different data sources;
it is multi-dimensional: it measures perception with respect to determined categories, such as for example:
   product quality,
   company policies,
   sustainability policies,
   financial situation;
it is relative: this index is based on comparison with competitors of a given public and/or private organisation. It does not show absolute values, but it is based on the perception of a determined brand with respect to similar brands in the same industry.

The Reputation Index (RI) is generated starting from a step for collecting a set of different forms of data, obtained from various data sources, so as to calculate an index with respect to several categories. Such data sources may for example consist of:
text portions (“posts”) on social networks;
reviews on public and/or private organisations;
job offers;
reviews on products and/or services;
news and/or articles relating to finance and/or concerning the specific industry of interest.

This set of different forms of data is then processed and analysed. For example, considering social network posts, which represent the most transient part of the index, a neural network-based classifier is constructed for each public and/or private organisation, which will allow posts to be split into several predefined categories, for example:
product posts: posts that talk about intangible products and services, such as customer care and support;
governance posts: posts that comment on external and internal policies of businesses and/or organisations;
CSR (“Corporate Social responsibility”) posts: posts concerning sustainability choices in the ethical, social and/or environmental field;
innovation posts: posts that propose new ideas regarding a particular product and/or service or propose the reintroduction of a product and/or service that is no longer available;
none: posts that do not belong to any of the classes above.

Once posts are separated into these categories, a Sentiment Analysis algorithm that will assign a predefined value to each post will be applied. Then, a user perception is modelled as a negative, neutral or positive opinion with respect to the subject-matter in question.

The set of different forms of data is stored in an appropriate database. Reviews relating to public and/or private organisations can be added to this database. These reviews can be used to provide a more stable index, especially in terms of size, governance and CSR. The index, same case applying to posts, is generated by applying a Sentiment Analysis algorithm to these reviews and, where possible, by exploiting the opinions expressed directly by the users (the “stars”).

Just like in the case of reviews, online job offers for a certain business and/or organisation can also be extracted and hence understand, based on revenue and offers on similar positions, how much this business and/or organisation is willing to pay its employees/collaborators. Businesses and/or organisations that pay more for certain positions with respect to their competitors, considering the same revenue, will have a higher governance and CSR index.

Product and/or service reviews can be acquired in order to generate an index for the “product/service” category from websites with a certain reliability, such as for example Amazon. User perception toward the product/service in question can be calculated from this index. Similarly, news and/or finance articles can be used to obtain an index for the “finance” category and to calculate the resulting perception. The database may consist of articles and social media posts on trading platforms, such as for example eToro.

Data sources present in the database may or may not contribute to an index size based on factors such as the volume of data available and the type of business and/or organisation. For example, a business review website such as Glassdoor may not have data about a certain brand, or it may not have a minimum number of reviews needed to draw conclusions. These problems can therefore be overcome by carrying out a source data pool that will contribute to a certain dimension of a given business and/or organisation. Ranking based on quality in terms of data volume and quality (if a data item from a reliable source is particularly low in volume) will weigh less than a source that has average quality but has sufficient information to contribute to that category.

The Reputation Index (RI) is therefore an index that measures the user/consumer perception in relation to the main businesses and/or world organisations in the following 5 categories that best represent the various facets of the reputation of a given business and/or organisation:
1) “Product Quality”: that is user perception on the quality of a product/service, intended as a set of tangible and intangible attributes;
2) “Innovation Capability”: that is how much users perceive that a particular business and/or organisation is capable of introducing product innovations (be they disruptive or incremental) into the market;
3) “Corporate Social Responsibility”: that is how much users perceive that a particular business and/or organisation is responsible from an environmental and social point of view;
4) “Management Reputation”: that is an evaluation of user perception of corporate choices. These include governance choices (partnership, merger & acquisition, etc.) and marketing choices (marketing campaigns, choice of influencers, etc.);
5) “Financial Growth Potential”: that is how much investors/experts believe that the stock and/or economic/financial performance of a given business and/or organisation will grow or drop in the future.

Therefore, Reputation Index (RI) allows to reduce the distance between the values of the consumer and the values expressed by the business and perceived by the end user of the product or service. This will allow to monitor and view the perception of the company during a specific period of time, that is with constant monitoring.

Therefore, Reputation Index (RI) has a multiple effect. On the one hand, the consumer will be able to evaluate and assess the performance of businesses and brands that best reflect his/her values. On the other hand, the business will be able to evaluate how it is perceived and, as a result, the actual impact of its corporate policies and communication of given values, in order to maintain their level or optimise it to improve it.

The method for evaluating the level of trust and expectations of users toward public and/or private organisations according to the present invention provides for creating a further index which measures how much a product and/or a service of a given public and/or private organisation is likely to be spread among users (Advocacy Index or AI). This Advocacy Index (AI) is calculated by selecting a portion of the public data (“posts”) coming from social networks and relating to the “product” category of the Reputation Index (RI) meeting a predefined requirement, that is exceeding a very high “sentiment” threshold. A high percentage above a high threshold indicates that many people have publicly expressed a strong enthusiasm for a given product and/or service to all their network of friends.

The Advocacy Index (AI) therefore aims to replicate one of the most widely used methods, typically a method consisting of an interview mostly by telephone, to measure the likelihood of consumer recommending a particular product or brand to relatives and friends. The data that feed this Advocacy Index (AI) are a derivative of the classification used to determine the Reputation Index (RI). In particular, data that were allocated to the “product” category of the Reputation Index (RI) can be used to generate the Advocacy Index (AI).

The resulting dataset is further classified by “sentiment” and “emotion”. The combination of positive plus values and negative minus values results in a value on a scale of 0 to 10. The change of this value over time results in the final output of this Advocacy Index (AI), which will be potentially applied to a given public and/or private organisation or to a single product/service of the public and/or private organisation.

A conventional technique was therefore used, applying it to unsolicited and public data volumes. This results in an advanced form of conventional advocacy indices, which takes into account the extemporaneity and genuineness of unsolicited opinion and, above all, the power of spread of the digital word of mouth. Businesses and/or organisations will then be able to assess the final impact that their products, or similar products, have on a very large audience. Advocacy is a phenomenon that catalyses new sales thanks to word of mouth and which, considering the same advertising investment, can be decisive in the success of a product. For a business and/or organisation, being able to control the advocacy value means being able to better calibrate the budgets invested in the spread of a given product and/or service.

Lastly, the method for evaluating the level of trust and expectations of users toward public and/or private organisations according to the present invention provides for the use of an analysis tool (“Polygons”) which allows to compare user groups based on various metrics. Firstly, a significant sample is extracted from a given user group. The user source or the sampling policy are not relevant to the analysis tool, provided that the sample is compared with similar groups.

Each user is considered as a set of the features thereof, which may vary in nature depending on the type of analysis required. In general, a user is defined as the combination of his socio-demographic features (sex, age, language, origin) and psychographic features (personality traits, behaviours, values, interests). The extraction of these characteristics is entrusted to specific artificial intelligence algorithms (proprietary and non-proprietary).

Following the selection of the features relevant to the analysis, they are normalised and coded, for each individual user, in an n-dimensional vector representing the user. A reduction in the dimensional space of the vectors-users is carried out, moving them from n dimensions to two or three dimensions, in order to be able to compare the various user groups thus processed.

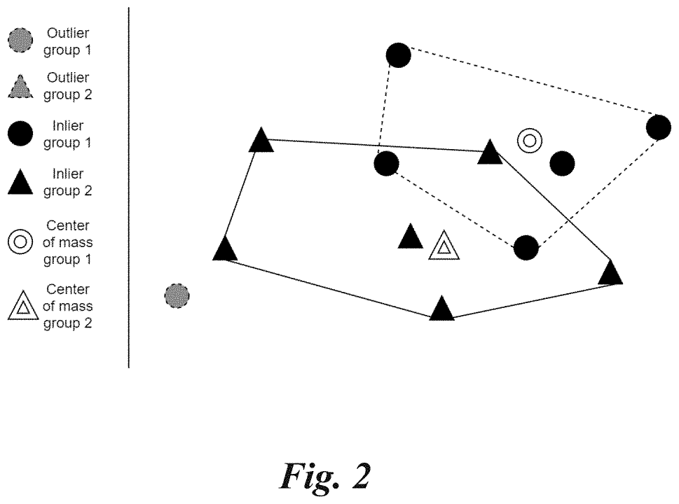

Regarding each user group thus transformed, a further outlier detection analysis is carried out in order to exclude elements of the sample that are too distant from the rest of the group and that would make the calculation of the subsequent comparison metrics less significant. As a matter fact, each user group may be represented as a polygon or a polyhedron in the plane (see FIG. 2), which is the reduction of the space complete with the features examined. This representation is obtained by calculating the convex hull of each subset (“inlier” user group) of the examined vector space, and it is defined by its vertices which are precisely the extreme users of the group. It is clear that the elimination of “outlier” users is therefore decisive for obtaining a convex hull that is significant for the purposes of the analysis.

Besides providing a compact view of the distribution of users belonging to the various groups, the representation obtained allows to extract comparison metrics using the properties of the flat geometry and solid geometry. For example, the area overlap index (Jaccard index) allows to identify the overlap between features of the various groups compared. Furthermore, the analysis of the centres of mass provides both a proximity index, by calculating the relative distance between the centres of the various polygons, and the identikit of a hypothetical target user of the relative group, as a list of features, obtained from the inversion of the dimensional reduction on the point.

Therefore, this analysis tool (“Polygons”) allows to listen to and interpret the interests and needs of a given group of persons, geographically located (country, city, metropolis, province, region) and, through this listening, to identify specific segments within, such as for example those discussing environmental issues, those discussing art, those discussing sports, etc. The main purpose is to identify the common interests of these different segmentations, which however belong to the same audience. For example, one purpose of this analysis tool (“Polygons”) could be to listen to citizens and to put public authorities in the best position to meet the needs of the target population (for example: is it better to invest in a football pitch or a new shopping mall?).

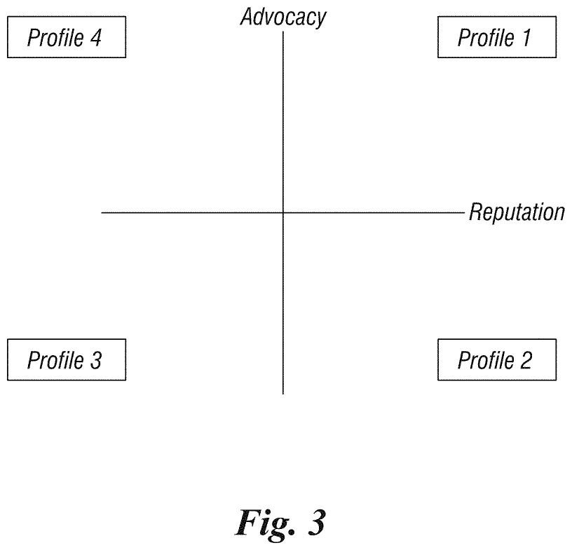

The combination of the processes described so far allows to arrive at an exhaustive summary of how a public and/or private organisation is perceived by its users. This summary is reported in the quadrant of FIG. 3 (schematised as “KPI6 Quadrant” in FIG. 1). The quadrants are typical market research displays. The quadrants use two dimensions (X, Y) to generate a matrix that describes four different profiles. In the quadrant of FIG. 3, besides the positioning X, Y, a third dimension Z, that is the surface of the point representing each public and/or private organisation, can be added. The values of the 3 dimensions X, Y, Z will be determined by the 3 indices described above, namely:
X: Reputation Index (RI),
Y: Advocacy Index (AI),
Z: Consumer Trust Index (C-TI).

The quadrant thus obtained will allow public and/or private organisations to understand the position occupied by the specific organisation, public or private, with respect to others.

In detail, public and/or private organisations with a “profile 1” (definable in jargon as “game changers”) which are capable of making the difference in the market, loved by everyone and always offers solutions that satisfy a sizeable number of consumers, are positioned in the upper-right quadrant, with high values of both the Advocacy Index (AI) and the Reputation Index (RI). By way of example relating to the automotive industry, in this section of the quadrant we could find electric car manufacturers who are focused on emissions and sustainable component development, with ambitious management and significant financial growth potential, but who—at the same time—are able to create emotions in drivers of this type of car to an extent that they share them publicly (e.g., the well-known US company Tesla, Inc.).

Public and/or private organisations with a “profile 2” (definable in jargon as “boy scouts”) which are perceived favourably by the public due to their ethics, product reliability and relationship with employees, but which are hardly subject to public decorations of use, are positioned in the lower-right quadrant, with high Reputation Index (RI) but not Advocacy Index (AI) values. In this section we could find, for example, companies that produce organic foods or medical equipment. Conventional banks, which have a very high reputation (due to good financial performance and a very high management reputation) but which, due to business dynamics, fail to capture the attention and enthusiasm of the general public around their brands, may fall into this section of the quadrant.

Public and/or private organisations with a “profile 3” (definable in jargon as “wannabe seducers”) which, in a manner diametrically opposite to organisations with “profile 1”, do not have a very high reputation and may, in the recent past, have experienced crises and scandals, for example at the management or product level, or which may have tampered with given environmental impact analyses results relating to their products, are positioned in the lower-left quadrant, with low values of both Advocacy Index (AI) and Reputation Index (RI). At the same time, due to the conventionality of the products or poor quality thereof, these organisations are not able to elicit “hype” from the public. Low-cost airlines or low-end manufacturing brands could be an example of these.

Public and/or private organisations with a “profile 4” (definable in jargon “punk-rockers”) which appear highly controversial are positioned in the upper-left quadrant, with high values of Advocacy Index (AI) but not of Reputation Index (RI), These, for example, could be organisations that are traditionally known to have reputation problems and/or create products with a very high level of addiction and very high spread potential. Examples thereof could be electronic cigarette companies, gambling companies, junk food distribution chains, and the like.

The area of the point, determined by the Consumer Trust Index (C-TI), differs for each public and/or private organisation. A greater area of the point, regardless of where the point is positioned on the quadrant, corresponds to a higher level of trust expressed by the consumer.

After defining the quadrant and the positioning of public and/or private organisations in their respective sections, the last analysis tool, that is “Polygons”, is applied. As mentioned above, “Polygons” is an analysis tool that allows users to compare user groups based on various metrics. “Polygons” will then be used to evaluate and understand how and how much various users of public and/or private organisations present in a particular section of the quadrant differ. Therefore, focus shifts to the end consumer and to the features thereof: socio-demographic (sex, age, language, origin) and psychographic (personality traits, behaviours, values, interests). Identifying the features of the users and/or customers and/or consumers thereof will allow organisations to direct a series of predefined actions aimed at improving the positioning thereof on specific user brackets. If effective, these actions will impact user perception, changing the index values and therefore the positioning of the organisation in the quadrant.

Therefore, it has been observed that the method for evaluating the level of trust and expectations of users toward public and/or private organisations according to the present invention attains the objects outlined above. In particular, with respect to the use of the Sentiment Analysis based algorithm alone as it happens in the method according to document US 2012/296845 A1, the further implementation of an Emotion Analysis allows to measure—with greater precision—the level of trust and the expectations of the users toward a specific organisation, such as for example a statutory corporation and/or a private business.

Furthermore, the method for evaluating the level of trust and expectations of users toward public and/or private organisations according to the present invention is not limited to processing the Consumer Trust Index (C-TI), but it also considers an additional dataset to classify them into subcategories (by means of a semantic classifier), so as to calculate the Reputation Index (RI). On the contrary, document US 2012/296845 A1 does not provide for any method capable of allowing to calculate the Reputation Index (RI). Reputation Index (RI) is a composite index and the description above outlines how this an index can be calculated automatically and in detail for a machine learning engineer.

Lastly, the method for evaluating the level of trust and expectations of users toward public and/or private organisations according to the present invention is capable of also calculating an Advocacy Index (AI), still through by combining Sentiment Analysis and Emotion Analysis, but on another dataset. As a matter fact, the advantage of the method according to the present invention lies in the fact that it is capable of distinguishing and using the various data streams acquired by the method in question.

Consumer Trust Index (C-TI), Advocacy Index (AI) and Reputation Index (RI) are required to generate the quadrant of FIG. 3 (KPI6 Quadrant), which is the core of the method according to the present invention and the actual invention with respect to the green score of US 2012/296845 A1. The combination of these indices is innovative, same case applying to the use and distinction of the various data streams to which the algorithms of the method according to the present invention are then applied.

The technical impact of the method according to the present invention is supported by a further analysis relating to users. In other words, the method according to the present invention does not simply analyse multiple data streams (in particular three data streams) relating to users of a specific brand, but instead it analyses the actual users, which are divided into “audiences” (one for each brand). Brand audiences are enriched (for example by extracting demographic information and interests from the personal feeds and biographies thereof) and they compared with each other using the “Polygons” analysis tool. This is in itself an innovation with respect to the teachings disclosed by the document US 2012/296845 A1, given that although known individually, the algorithms of the method according to the present invention have never been combined in this manner or for such use. The “Polygons” analysis tool alone may be worthy of a publication.

In conclusion, the “Polygons” analysis tool and the quadrant of FIG. 3 (KPI6 Quadrant) are the two main technological innovations on which the method according to the present invention is based: stopping at the Consumer Trust Index (C-TI) and/or the reputation Index (RI) would be an error. The combination of the “Polygons” analysis tool and the quadrant of FIG. 3 (KPI6 Quadrant) allows to determine which decisions to make, as these two elements provide a strengthened view of the level of brands and audiences thereof. As mentioned above, the method according to the document US 2012/296845 A1 uses the green score, which are similar but more primitive than the Consumer Trust Index (C-TI), to determine whether or not to invest in a “green investment” brand. The technical impact of the combination of the “Polygons” analysis tool and the quadrant of FIG. 3 (KPI6 Quadrant) is to decide on the investment to be made by a given brand as well as especially to allow brands to weigh targeted actions to improve or maintain the score thereof.

The method for evaluating the level of trust and expectations of users toward public and/or private organisations according to the present invention thus conceived is susceptible in any case to numerous modifications and variations, all falling within the scope of the same inventive concept; furthermore, all the details can be replaced by technically equivalent elements.

Therefore, the scope of protection the invention is defined by the attached claims.

1. A method for evaluating the level of trust and expectations of users toward public and/or private organisations, the method comprising the steps of:
collecting a first user-generated textual dataset (UGC) on web platforms or social networks;
processing and analysing the first user-generated textual dataset (UGC), by means of a first algorithm and a second algorithm, in order to obtain a first user trust index (Consumer Trust Index or C-TI);
collecting a second dataset comprising both user-generated textual dataset (UGC)—on web platforms or social networks—and data obtained from various sources and relating to a given public or private organisation;
processing and analysing the second dataset, by means of said first algorithm, in order to obtain a second user perception index (Reputation Index or RI) with respect to a given public or private organisation;
selecting, from the second dataset, a data portion meeting a predefined requirement, in order to obtain a third index (Advocacy Index or AI) which measures how much a product or a service of a given public and/or private organisation is likely to be spread among users;
splitting the users, by means of an analysis tool (“Polygons”), into user groups based on predefined features of said users;
generating a quadrant with two dimensions (X, Y) defining four separate sections for four different profiles of public or private organisations, wherein each public or private organisation is represented by a point in at least one of said sections, wherein the value of a first dimension (X) is determined by said second index (Reputation Index or RI), the value of the second dimension (Y) is determined by said third index (Advocacy Index or AI) and the value of a third dimension (Z), which coincides with the dimension of each point, is determined by said first index (Consumer Trust Index or C-TI);
after defining the positioning of the public or private organisations within said quadrant, applying said analysis tool (“Polygons”) in order to evaluate and understand how and how much the users of public or private organisations present in a determined section of the quadrant differ, so as to allow said public or private organisations to direct—on specific user brackets—a series of predefined actions aimed at improving the positioning thereof in the quadrant, changing the index values.

2. A method according to claim 1, wherein said first algorithm is based on a Sentiment Analysis, which allows to extract text portions of predefined meaning from said first user-generated textual dataset (UGC), wherein the result of said first algorithm is a distribution of each text portion between two sets (positive and negative).

3. A method according to claim 2, wherein said first algorithm is based on a model consisting of two blocks, wherein a first block is represented by a language model which allows to extract features with predictive content from a text, while a second block consists of a Wide Convolutional Neural Network which exploits the constructs of each text portion by analysing unigrams, bigrams and trigrams.

4. A method according to claim 1, wherein said second algorithm is based on an Emotion Analysis, which allows to identify and analyse, in each text portion of said first user-generated textual dataset (UGC), emotions selected from the group consisting of:
joy,
admiration,
sadness,
fear,
anger,
disapproval,
surprise,
malice,
boredom.

5. A method according to claim 1, wherein said first user-generated textual dataset (UGC), once analysed by said first algorithm and by said second algorithm, is stored in a dataset that is subsequently subjected to a noise-cancelling step to be cleaned, by deleting nonsensical text portions or removing or masking noise elements.

6. A method according to claim 1, wherein for each data item of said second dataset a classifier based on neural networks is constructed for each public or private organisation, said classifier allowing to split each data item into various predefined categories.

7. A method according to claim 6, wherein a Sentiment Analysis algorithm is applied to each data item to assign a predefined value to each data item.

8. A method according to claim 6, wherein each data item of said second dataset is stored in a database to which reviews or other data of said public or private organizations, as well as reviews of products or services provided by said public or private organisations, can be added.

9. A method according to claim 1, wherein the predefined features of said users are normalised and coded, for each individual user, in an n-dimensional vector representing said user, wherein a reduction of the dimensional space of each vector-user is carried out, moving it from n dimensions to two or three dimensions, in order to represent each user group as a polygon or polyhedron in the plane.
